(19) United States
(12) Patent Application Publication
(10) Pub. No.: US 2026/0042283 A1
(43) Pub. Date: Feb. 12, 2026

(54) PACKAGING STRUCTURE WITH OPTIMIZED SURFACE ENERGY

(71) Applicant: Sonoco Development, Inc., Hartsville, SC (US)

(72) Inventors: Sydney Birx, Hartsville, SC (US); Phillip Watford, Hartsville, SC (US)

(21) Appl. No.: 18/799,630

(22) Filed: Aug. 9, 2024

(51) Int. Cl. B32B 27/08; B32B 7/12; B32B 27/32; B32B 37/12; B65D 75/32; B65D 75/58; C09J 7/24; C09J 7/38

(52) U.S. Cl. CPC B32B 27/08; B32B 7/12; B32B 27/32; B32B 37/12; B65D 75/322; B65D 75/5838; C09J 7/243; C09J 7/38; B32B 2307/748; B32B 2323/04; C09J 2203/37; C09J 2301/204; C09J 2301/302

(57) ABSTRACT

A recyclable packaging structure for use in a packaging structure. The packaging structure comprises a first structure having an inner surface and an outer surface, and a second structure having an inner surface and an outer surface. The outer surface of the second structure is adhesively bonded to the inner surface of the first structure by an adhesive layer. The surface energy of the inner surface of the first structure is above 42 dyne, and the surface energy of the outer surface is between 32-42 dyne.

### FIELD OF THE INVENTION

The present disclosure relates in general to packaging for products, and more particularly to recyclable packaging comprising a resealable structure. The invention also comprises methods for manufacturing the recyclable packaging structures.

### BACKGROUND

A variety of food and non-food products are packaged using flexible packaging materials formed primarily of laminations of one or more of polymer films, metallized polymer films, paper, metal foil, and the like. In many instances, packages contain products that may be used or consumed a little at a time, and the products may be susceptible to being adversely affected (e.g., becoming soggy, drying out, etc.) by exposure to the surrounding environment. Accordingly, there is a desire to be able to reclose a package after its initial opening to keep product that remains in the package fresh.

The reclose mechanism for flexible packaging often involves the use of a releasable adhesive (such as a pressure sensitive adhesive (PSA)) which is easily releasable and, in embodiments, also resealable with applied finger pressure. The flexible packages themselves are often formed using a polyethylene terephthalate (PET) and metalized oriented polypropylene (MOPP) film laminate, which unfortunately is not curbside recyclable. The use of polyethylene (PE) film would allow recyclability but creates other issues. In many cases, the PE film is provided pre-treated with a surface treatment prior to lamination and formation of flexible laminates and packages. The surface treatment (e.g., corona treatment) may alter the surface properties of the material, for example to make the surface more receptive to inks and other materials. However, the surface treatments also cause PSA to have a high affinity for the treated PE film. The bond between the PSA and the treated PE film is too strong and the PSA does not easily release from the PE film. The film stretches and the opening mechanism fails in many cases (e.g., a “lockup”). Likewise, using an untreated PE film may not provide a strong enough seal for the portions of the film that are to remain securely adhered to one another (e.g., not releasable, permanently adhered zones).

Thus, there exists a need for a recyclable film and/or packaging structure utilizing a PE film with an optimized surface energy for use with releasable adhesives such as PSAs. Through ingenuity and hard work, the present inventor has developed such a product.

### SUMMARY

In an embodiment, a PE film with an optimized surface energy is provided herein. In other embodiments, a flexible resealable laminate utilizing such a PE sealant film and PSA is provided herein. In an embodiment, the laminate may be a multi-structure laminate. In an embodiment, the PE film may comprise multiple surface energy levels. The different surface energies may provide the film, laminate, or resulting structure with varying affinities for different materials. For example, a first structure defines a first surface energy which provides a releasable surface for pressure sensitive adhesive and other releasable adhesives. A second structure defines a second surface energy, being greater than the first surface energy. The second surface energy may render the surface more receptive to adhesives, inks and other materials and may have a greater affinity for adhesives.

Each of the first structure and the second structure may comprise the same polymer, such that the resulting structure is curbside recyclable in the regular stream. Thus, the different surface energies of the laminate structure create a peelable surface and a permanently adhered surface, forming a recyclable resealable laminate.

In an example embodiment a recyclable packaging structure is provided. The packaging structure comprises a first structure having an inner surface and an outer surface, and a second structure having an inner surface and an outer surface. The outer surface of the second layer is adhesively bonded to the inner surface of the first structure by an adhesive layer. The surface energy of the inner surface of the second structure is at least 42 dyne and the surface energy of the outer surface of the first structure is between 32-42 dyne.

In some embodiments, the surface energy of the first structure may be between 34 and 40 dyne. In some embodiments, the surface energy of the first structure may be between 36 and 38 dyne. In some embodiments, the first structure and the second structure may comprise the same polymer. In some embodiments, the adhesive layer may be solvent based. In some embodiments, the adhesive layer may comprise pressure sensitive adhesive. In some embodiments, the pressure sensitive adhesive may be pattern applied. In some embodiments, the pressure sensitive adhesive may have a strong affinity for the first structure. In some embodiments, the pressure sensitive adhesive may have a weak affinity for the second structure. In some embodiments, the first structure and the second structure may be polyethylene.

In another example embodiment a method of making a recyclable laminate is provided. The method comprises providing a first structure defining an initial surface energy of 32 dyne or less. The method further comprises providing a second structure defining a surface energy of 42 dyne or more. The method further comprises applying a surface treatment which increases the initial surface energy to a second surface energy to the first structure. The second surface energy is between 32 and 42 dyne. The method further comprises applying an adhesive layer to at least one of the first structure or the second structure and laminating the first structure and the second structure.

In some embodiments, the adhesive layer may comprise a pressure sensitive adhesive. In some embodiments, the pressure sensitive adhesive may have a weak affinity for the first structure and a strong affinity for the second structure. In some embodiments, the adhesive may be a solvent based adhesive. In some embodiments, the first structure and the second structure may be polyethylene.

In yet another example embodiment a recyclable packaging structure is provided. The recyclable packaging structure comprises a first structure having an inner surface and an outer surface, and a second structure defining an inner surface and an outer surface. The outer surface of the second structure being adhesively bonded to the inner surface of the first structure by an adhesive layer to form a laminate. The packaging structure further comprises a repeatedly openable and closable flexible structure which comprises prior to initial opening a first score line in the laminate defining an outer layer opening portion and a second score line in the laminate defining an inner layer opening portion where the outer layer opening portion is larger in area than the inner layer opening portion and extends beyond a periphery of the inner layer opening portion. The openable and closeable flexible structure further comprises an inner layer upper surface comprising a first marginal region surrounding the second laminate score line and a non-detachable flap comprising the outer layer opening portion and the inner layer opening portion. The outer layer lower surface comprises a second marginal region comprising at least a portion of a periphery of the outer layer opening portion lower surface. The first marginal region of the openable and closeable flexible structure is releasable adhered to the second marginal region, wherein at least one of the first structure or the second structure comprise polyethylene. The surface energy of the polyethylene in the first or the second marginal region is between 32 and 42 dyne, and the surface area within the second score line and outside of the first score line is at least 42 dyne.

In some embodiments, the surface energy of the polyethylene structure in the first or second marginal region is between about 34 and 40 dyne. In some embodiments, the surface energy in the first or second marginal region is about 36 and 38 dyne.

In yet another example embodiment a method of making a recyclable laminate is provided. The method comprises providing a first polyethylene film defining an initial surface energy of 32 dyne or less and providing a second polyethylene film. The method further comprises pattern applying a first surface treatment to the first polyethylene film such that the surface treatment increases the initial surface energy in a reseal region to a second surface energy between 32-42 dyne. The method further comprises pattern applying a second surface treatment to the first polyethylene film. The second surface treatment increases the initial surface energy to a third surface energy of at least 42 dyne, in an area which is not the reseal region. The method further comprises applying an adhesive layer to at least one of the first structure or the second structure and laminating the first structure and the second structure.

In some embodiments, the adhesive layer may comprise a pressure sensitive adhesive.

### BRIEF DESCRIPTION OF THE SEVERAL VIEWS OF THE DRAWINGS

Having thus described the disclosure in general terms, reference will now be made to the accompanying drawings, which are not necessarily drawn to scale, and wherein:

FIG. 1A illustrates a cross-section of a laminate, in accordance with some embodiments discussed herein;

FIG. 1B illustrates a cross-section of a laminate, in accordance with some embodiments discussed herein;

FIG. 2 illustrates a cross-section of a laminate in a closed configuration, in accordance with some embodiments discussed herein;

FIG. 2B illustrates a cross-section of the laminate of FIG. 2A in an open configuration, in accordance with some embodiments discussed herein;

FIG. 3 illustrates an example process of forming a laminate, in accordance with some embodiments discussed herein;

FIG. 4A illustrates a perspective view of a flexible package made from the example laminate, in a closed configuration, in accordance with some embodiments discussed herein;

FIG. 4B illustrates a perspective view of the example flexible package of FIG. 4A in an open configuration, in accordance with some embodiments discussed herein;

FIG. 5 illustrates a perspective view of an example flexible package made from the example laminate in a closed configuration, in accordance with some embodiments discussed herein;

FIG. 6A illustrates a perspective view of an example container with a lidding member made from the example laminate, in a closed configuration, in accordance with some embodiments discussed herein; and

FIG. 6B illustrates the example container of FIG. 6A, in an open configuration, in accordance with some embodiments discussed herein.

### DETAILED DESCRIPTION

The present inventions now will be described more fully hereinafter with reference to the accompanying drawings, in which some but not all embodiments of the invention are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

In an embodiment of the invention, a flexible packaging laminate is constructed to have an integral opening and reclose feature. In some embodiments, the flexible packaging laminate may further include a pull tab and a tamper-evident feature. The laminate is constructed as a multi-layer structure by adhesively laminating a first structure to a second structure, wherein each of the first and second structures may comprise the same structure, for example polyethylene, polyethylene terephthalate, polypropylene, etc.

In some embodiments, both a pressure sensitive adhesive and a permanent adhesive may be applied to one or both of the structures prior to lamination. In other embodiments, only a pressure sensitive adhesive or a permanent adhesive is utilized in the invention. Once the laminate is formed in this manner, scoring operations are performed.

In an embodiment, one or more scoring operations are performed on each side of the laminate. In an embodiment, some scoring operations penetrate only through a part of the thickness of the laminate; in particular, a scoring operation performed on the side of the laminate adjacent the first structure results in penetration through the first structure, but without complete penetration through the second structure, and preferably without any substantial penetration, and more preferably without any penetration, into the second structure. Likewise, a scoring operation performed on the side of the laminate adjacent the second structure results in penetration through the second structure, but without complete penetration through the first structure, and preferably without any substantial penetration, and more preferably without any penetration, into the first structure. However, in some scoring operations set forth herein, the scoring comprises a complete penetration through both the first and second structure. The scoring operations may form the peelable/reclosable flap, the pull tab, and the tamper-evidence features, as further described below.

In some embodiments, the flexible laminate may be formed from bonded structures of polyethylene. In some embodiments, the bonded structures may be oriented polyethylene. In some embodiments, the polyethylene may be medium density polyethylene (MDPE), or high-density polyethylene (HDPE). In some embodiments, the structures may be machine-direction oriented (“MDO”) or biaxially oriented (“BO”). Oriented polyethylene, in general, provides a heat-resistant, non-extensible film. These characteristics are important for various aspects of the manufacturing process, such as printing and die cutting or perforating.

In an embodiment, either or both structures may be crosslinked. Any crosslinking methods can be utilized to crosslink the structures layers, which may include, but is not limited to chemical, physical, or mechanical crosslinking. Crosslinking may decrease the extensibility of the laminate, improve barrier properties of the laminate, and/or increase heat resistance of the laminate. In an embodiment, electron beam crosslinking methodologies may be applied to crosslink the first and/or second structure.

Turning to the figures, in some embodiments a flexible laminate 100 may comprise a first structure 110 and a second structure 115 adhesively bonded by an adhesive layer 120. In some embodiments, the first structure 110 may define an inner surface 110a and an outer surface 110b. Similarly, the second structure 115 may define an inner surface 115a and an outer surface 115b. The inner surface 110a of the first structure 110 may correspond to an inner surface 100a of the flexible laminate 100, and the outer structure 115b of the second structure 115 may correspond to an outer surface 100b of the flexible laminate structure 100.

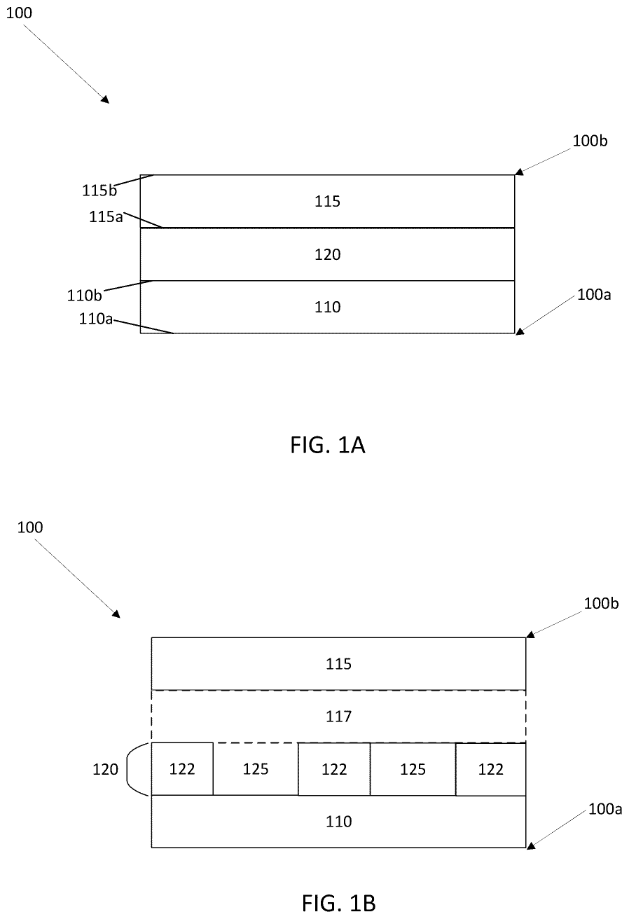

In some embodiments, illustrated in FIG. 1B the flexible laminate 100 may optionally include an ink layer 117 positioned between the second structure 115 and the adhesive layer 120. In this regard, the ink layer 117 may be printed, reverse printed, or the like. Thus, the ink layer 117 may be positioned on the inner surface 115a of the second layer 115.

In some embodiments, the first structure 110 and the second structure 115 may be the same material, for example, polyethylene. The use of the same material in each of the structures provides recyclability for the flexible laminate 100. In this regard, as the flexible laminate only comprises one material and a de minims amount of adhesive the flexible laminate 100 may be recyclable in the regular stream (e.g., curbside).

In some embodiments, the flexible laminate 100 may include additional layers to provide desired properties while maintaining the recyclability of the laminate. For example, the laminate may be configured to provide barrier properties, including moisture, water, carbon dioxide, and/or oxygen barriers. In some embodiments, the laminate may include a metalized layer. In some embodiments, the first structure 110 or the second structure 115 may be metalized 118 to provide improved barrier properties. Since the metalized layer will be de minimis, the flexible laminate 100 will be readily recyclable. In some embodiments, the metallization may be on one side of either the first structure 110 or the second structure 115, while in other embodiments, both the first structure 110 and the second structure 115 may be metalized.

In some embodiments, the laminate may have a moisture barrier. The moisture barrier may be used to improve the barrier properties of the laminate 100. In some embodiments, the first structure or second structure may include a barrier layer providing a barrier against the passage of moisture and/or oxygen. In some applications such as the packaging of moisture-sensitive products (e.g., cookies or similar products that tend to be degraded when exposed to the environment), it is important to provide a moisture barrier. The barrier layer can comprise any of various polymer-based barrier materials including barrier polymer films such as ethylene vinyl alcohol copolymer (EVOH), polyamide, and the like; metallized polyolefin films such as polyethylene, polypropylene, oriented polypropylene, and the like; aluminum oxide-(AlOx)-coated polymer films; silicon oxide-(SiOx)-coated polymer films; metal foil such as aluminum foil; and others. Although the term “barrier layer” is used in connection with metallized films to refer to the entire metallized film, it will be recognized that it is the layer of metal that provides the barrier function. Likewise, it is the AlOx or SiOx coating that provides the barrier function in the ceramic-coated films, but the entire film nevertheless is referred to herein as a “barrier layer”.

In order to be a resealable packaging the first structure 110 and the second structure 115 must be adhered together in a manner such that the first structure 110 and the second structure 115 may be partially separated and resealed together a number of times.

Thus, with reference to FIG. 1B the adhesive layer 120 may comprise both a permanent adhesive 122 and a pressure sensitive adhesive 125 or similar releasable adhesive. The adhesive layer 120 may comprise a pattern application of each of the permanent adhesive 122 and the pressure sensitive adhesive 125. The pattern application provides for sections of permanent adherence between the first structure 110 and the second structure 115 and a resealable portion. In some embodiments, the adhesive layer 120 (e.g., each of the permanent adhesive 122 and the pressure sensitive adhesive 125) may be solvent based. In some embodiments, the adhesive layer 120 may comprise only a pressure sensitive adhesive and no permanent adhesive will be required due to the surface energy differences discussed herein.

The first structure 110 and the second structure 115 may each comprise a dyne level, which is a measure of the surface energy of the surface (e.g., inner surface and outer surface) of the material. The surface energy of each structure is an indication of the structures affinity to create strong bonds at the interface between two structures. In this regard, a high surface energy may create stronger local bonds, while a low surface energy may create weaker bonds.

The inventors have discovered that adhesives, including pressure sensitive adhesive have a high affinity for polymer films having a high dyne level or surface energy. As such, even pressure sensitive adhesives, or other releasable adhesives may create strong bonds at high dyne levels. Thus, to create the flexible laminate 100 such that the pressure sensitive adhesive 125 may create a resealable area, the surface energies of the first structure 110 and the second structure 115 may be different or the surface energy of at least one of the first 110 or the second structure 115 may be different in different areas. That is, the surface energy may comprise a pattern on the surface of the first 110 or the second structure 115.

Surface energies of polymer films may be controlled and/or adjusted with the use of surface treatments. In general, surface treatments may increase the surface energy of the polymer film. In some embodiments, a surface treatment may be a corona flame treatment. A polyethylene film, for example may comprise an initial surface energy of around 32 dyne. Corona flame treatment may raise the surface energy of the film from around 32 to up to about 42.

A surface treated polyethylene film may have a surface energy around 42 dyne. At this surface energy, both permanent adhesive and pressure sensitive adhesives or other releasable adhesives may have a high affinity for the treated surface and may become permanently sealed to the surface. Thus, the resulting flexible laminate would not be resealable.

In this regard, to create a resealable flexible laminate, a dyne level between 32-42 is desired, for at least one of the structures or for at least one marginal reseal region between the structures. Thus, one or both of the structures may undergo a partial surface treatment to increase the surface energy to above 32 dyne while keeping the surface energy below 42 dyne, thereby creating a surface which will release the pressure sensitive adhesive. In this regard, one or both of the laminate surfaces may be pattern treated such that the surface energy of the releasable portion of the laminate defines a surface energy above 32 dyne and less than 42 dyne, while the remainder of the laminate defines a surface energy above 42 dyne.

In some embodiments, the first structure 110 may define a releasable surface energy between 32-42 dyne, between 32-40 dyne, between 34-40 dyne, between 36-40 dyne, between 38-40 dyne, between 32-34 dyne, between 32-36 dyne, between 32-38 dyne. In some embodiments, the releasable surface area of this first structure 110 may comprise a pattern and may not be created via a flood-treatment of the entire surface. In this regard, the pressure sensitive adhesive 125 may be releasable from the first structure 110, at least partially. The second structure 115 may define a surface energy at or above 42 dyne. In this regard, the pressure sensitive adhesive 125 and/or the permanent adhesive 122 may have a high affinity for the second structure 115.

In some embodiments, the flexible laminate 100 may have a durometer value and a tensile strength sufficient to be die cut. In some embodiments, the die cut may be a continuous line, and in other embodiments the die cut may consist of perforations through the flexible laminate 100. In some embodiments, each of the first and second structures of the laminate may have a durometer value and a tensile strength to withstand a die cut and/or perforation without reaching the other structure.

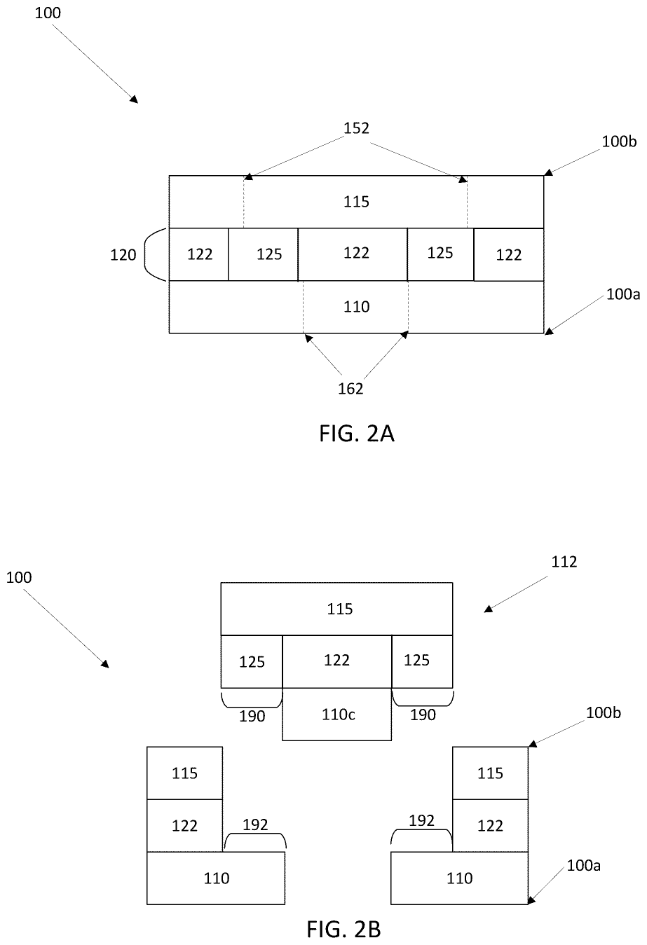

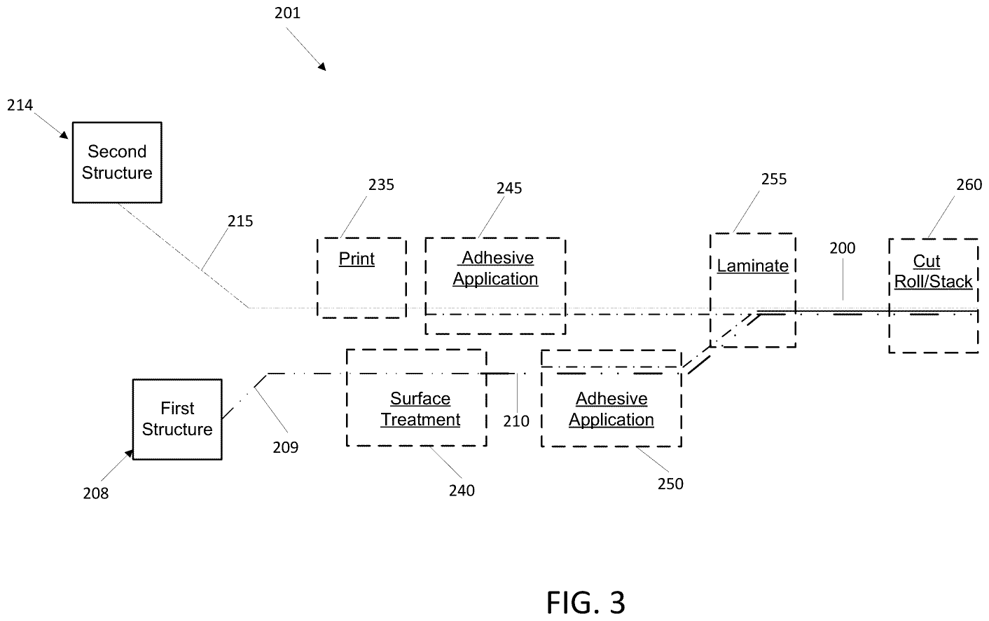

Turning to FIGS. 2A-B, the surface energies of each of the first structure 110 and the second structure 115 enable the flexible laminate 100 to create a resealable opening therethrough. In some embodiments, the first structure 110 may comprise a first line of weakness 162 and the second structure 115 may comprise a second line of weakness 152. In some embodiments, each of the first line of weakness 162 and the second line of weakness 152 may extend through the respective structure, but not into the adhesive layer 120, while in other embodiments the line of weakness may penetrate into the adhesive layer 120 but not the opposing structure.

The lines of weakness provide an opening and a flap 112 of the flexible laminate as illustrated in FIG. 2B. The flap 112 is created when the pressure sensitive adhesive 125 releases from the first structure 110 thereby defining a peripheral region 192 on the first structure 110, and a marginal region 190 on the second structure 115. The marginal region 190 comprises the pressure sensitive adhesive 125 may reseal to the peripheral region 192 of the first structure 110. The first line of weakness 162 within the first structure 110 further causes a portion of the first structure 110 to be removed with the second structure 115 upon opening. The permanent adhesive 122 pattern applied within the pressure sensitive adhesive 125 causes a center portion 110c of the first structure 110 to be secured onto the second structure 115 there by creating an opening through the flexile laminate.

### Method of Manufacture

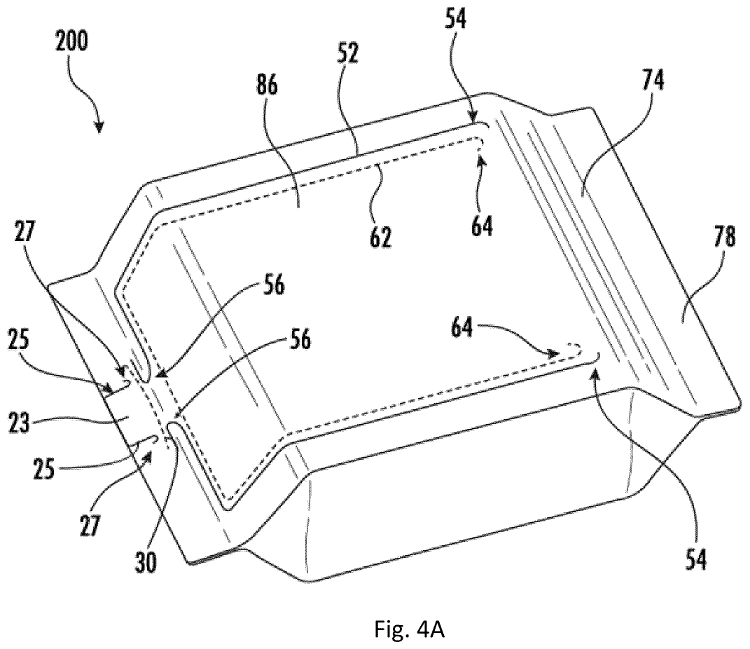

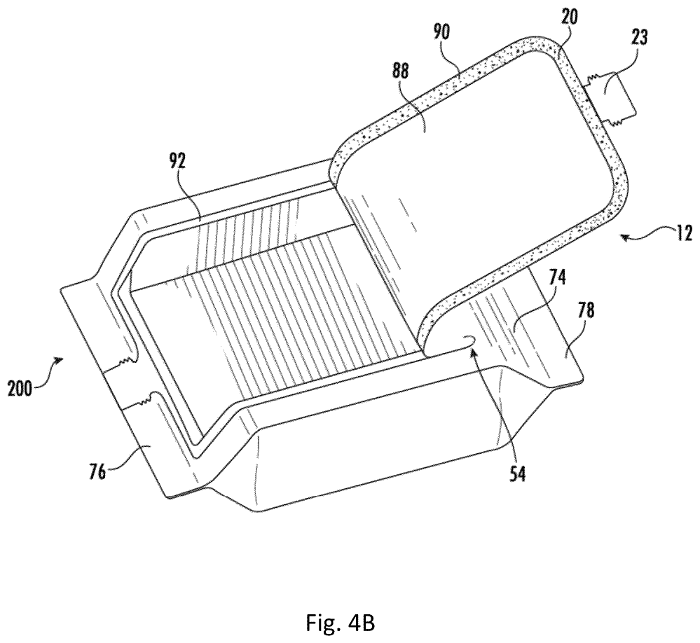

A flexible laminate as discussed may be formed from method 201. The method 201 may include providing an untreated structure 209 from a first roll 208. The untreated structure 209 may define a dyne level between 32-42 dyne. The untreated structure 209 may be advanced to a surface treatment station 240, wherein the untreated structure 209 undergoes a surface treatment. In some embodiments, the surface treatment may increase the surface energy of the untreated surface. In an embodiment, the surface treatment may be pattern applied to the surface of the structure 209. In some embodiments, the surface treatment may increase the entire untreated surface to the same dyne level, while in other embodiments the surface treatment may be pattern applied such that different regions of the surface define different dyne levels. For example, the surface treatment may increase the surface energy in a first marginal region, and/or second marginal region (e.g., 90 and 92 of FIG. 4B) between 32 and 42 dyne, and increase the remainder of the surface of the structure to at least 42 dyne.

The treated structure may be a first structure 210. In some embodiments, the surface treatment may be a corona flame treatment or similar treatment which increases the surface energy of the structure. In some embodiments, after surface treatment, the first structure 210 may be advanced to an adhesive application station 250. In some embodiments, the adhesive application station 250 may apply one or more various adhesives to the first structure 210, optionally in a pattern application. In other embodiments, the first structure 250 may not undergo an adhesive application.

A second structure 215 may be advanced from a second roll 214. In some embodiments, the second structure 215 is a treated structure and may define a surface energy at or above 42 dyne. The second structure 215 may be advanced to a print station 235. At the print station 245 the second structure may be printed, reversed printed, or other method of printing. After printing, in some embodiments the second structure 245 is advanced to an adhesive application station 245. In some embodiments, the adhesive application station 245 may apply one or more adhesives onto the second structure 215, optionally in a pattern application, while in other embodiments the adhesive application station 245 may be skipped.

In this regard, in some embodiments, pressure sensitive adhesive (e.g., 125 FIG. 1B) and permanent adhesive (e.g., 122 FIG. 1B) may be applied at the same adhesive application station 245, 250, or in some embodiments the adhesive application station 245 may apply permanent adhesive, while the adhesive application station 250 may apply pressure sensitive adhesive.

After application of the adhesives each of the first structure 210 and the second structure 215 are laminated at a lamination station 255 to form the flexile laminate 200. Optionally after lamination the flexible laminate 200 may be advanced to a packaging station 260 to be cut, rolled, stacked, or otherwise prepared for transportation or application for subsequent processing in a second, offline scoring phase of the manufacturing process, and a third, off line application phase of the manufacturing process. In some embodiments, the scoring steps of the invention may be performed in-line with the lamination steps. In the process of the invention, the manufacture of the laminate and the incorporation of the opening/reclose features in the laminate are conducted in an in-line fashion as part of the same overall process. The process of the invention thus is much more efficient and less costly.

Manufacturing equipment may be provided which can apply adhesive, laminate layers, and score the laminate within the same processing line. In an embodiment, the scoring equipment comprises a laser scoring device. The depth of the score line formed by a laser can be regulated by regulating the power output or beam intensity of the laser beam, the width or spot size of the laser beam, and the amount of time a given spot on the film surface is irradiated by the beam. These factors generally are selected based on the characteristics of the material being scored. Some materials are more readily scored by lasers than other materials, as known in the art. The depth of the score line formed by the laser can be regulated by regulating the power output or beam intensity of the laser beam, the width or spot size of the laser beam, and the amount of time a given spot on the film surface is irradiated by the beam. These factors generally are selected based on the characteristics of the material being scored.

### Example Structure

The flexible laminate 100, may be used to form a flexible packing structure, as described within U.S. application Ser. No. 17/031,154, which is herein incorporated by reference in its entirety. The flexible laminate 100, may be used as a lidding member for a thermoformed tub, as described within U.S. application Ser. No. 17/508,075, which is herein incorporated by reference in its entirety. As described above, the first structure 110 may also be referred to as an inner structure, and the second structure 115 may be referred to as an outer structure. In an embodiment, the outer structure has a higher surface energy, on its surface which faces the inner structure, than the inner structure has on its surface which faces the outer structure.

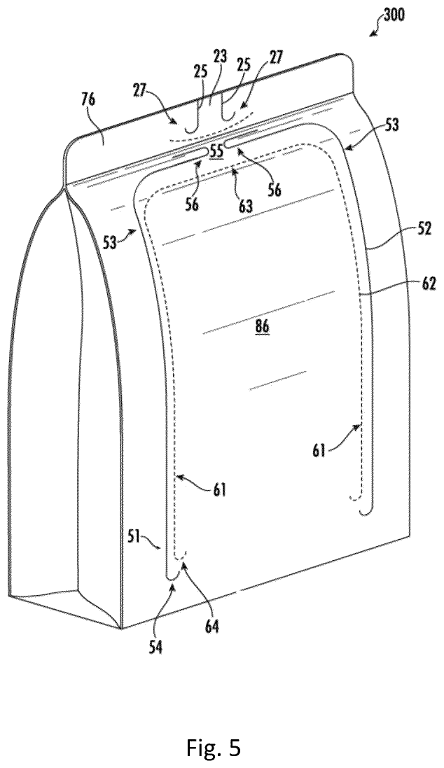

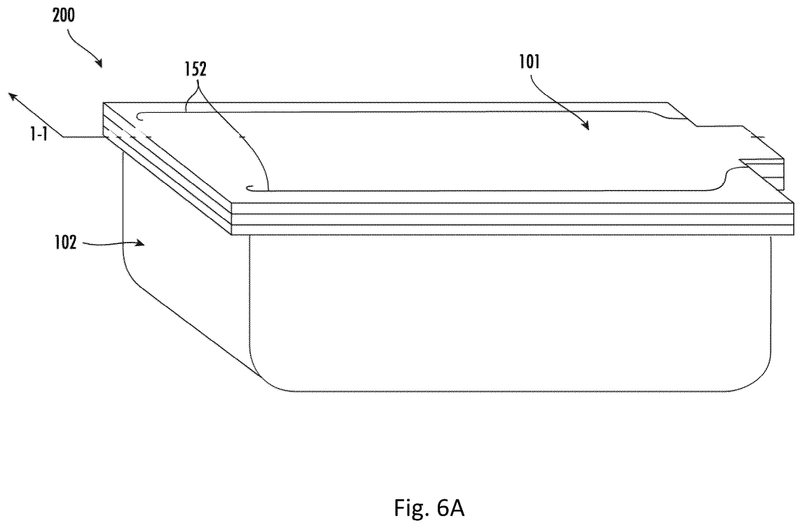

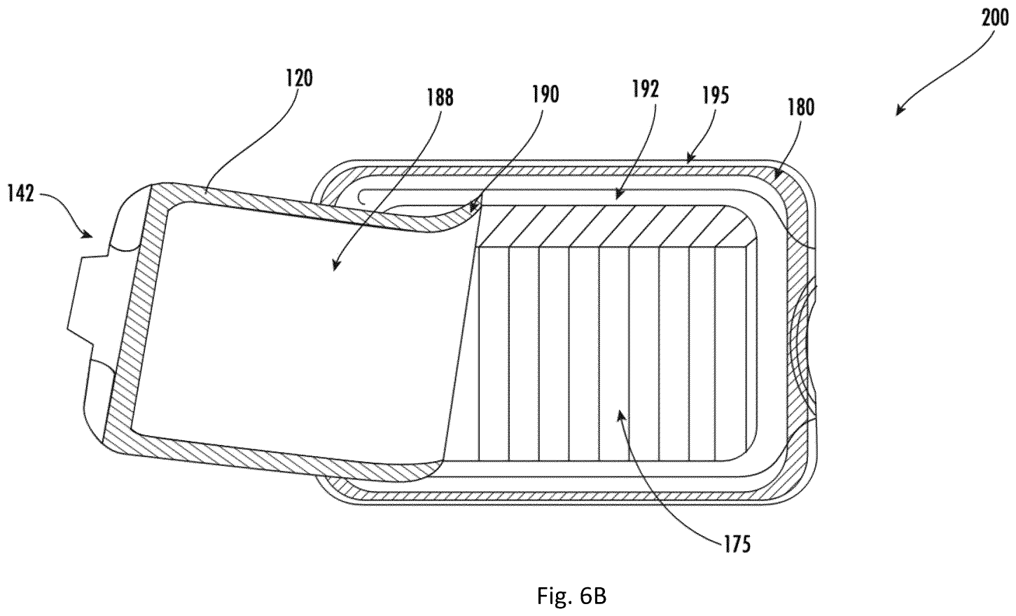

FIGS. 4A-4B illustrate an example flexible packaging structure 200 made from the flexible laminate 100 in a closed and open configuration respectively. Similarly, FIG. 5 illustrates an example flexible packaging structure 300 made from the flexible laminate 100 configured as a standup pouch. FIGS. 6A-6B illustrate the flexible laminate 100 configured as a flexible lidding member 101 adhered to a container 102 in a closed and an open configuration.

In both the packaging structure, and the lidding member an outer line of weakness (also referred to herein as a “first score line”) is formed in the outer structure to define an outer layer opening portion that can be lifted out of the plane of the outer structure. Similarly, an inner line of weakness (also referred to herein as a “second score line”) is formed in the inner structure to define an inner layer opening portion that can be lifted out of the plane of the inner structure. The outer and inner opening portions are attached to each other such that the outer and inner opening portions can be lifted out of the plane as a unit, thereby creating an opening through the packaging structure defined by the inner line of weakness.

The outer opening portion is larger in area than the inner opening portion and has a marginal region that extends beyond the peripheral edge of the inner layer opening portion. When the outer and inner layer opening portions are lifted out of the plane to create the opening, an underlying portion of the inner structure in registration with the marginal region of the outer layer opening portion is exposed adjacent the opening. Therefore, after initial lifting of the outer and inner layer opening portions, the opening through the structure can be reclosed by adhering the marginal region of the outer layer opening portion to the underlying portion of the inner structure via the pressure sensitive adhesive.

In an embodiment, the laminate may be thereafter scored to form one or more outer lines of weakness (also referred to herein as “score lines”) through the thickness of the outer structure, one or more inner score lines through the thickness of the inner structure, and one or more throughcut score lines which extend through the outer structure and the inner structure.

In an embodiment, the outer score line delineates the outer layer opening portion of the outer structure that is separable from the remainder of the outer structure along the outer score line, and the inner score line delineates the inner layer opening portion of the inner structure that is affixed to the outer opening portion by the adhesive and is separable from the remainder of the inner structure along the inner score line. The outer line of weakness or score line preferably penetrates through the thickness of the outer structure but not through the inner structure. Similarly, the inner score line preferably penetrates through the thickness of the inner structure but not through the outer structure.

In an embodiment, a separate inner score line defines a portion of the tamper evidence feature. In an embodiment, a throughcut score line penetrates through the thickness of the inner and outer structure and defines at least a portion of the pull tab. In an embodiment, the score lines are formed by laser scoring. However, other methods, such as mechanical scoring, die cutting, kiss cutting, or a combination thereof may be utilized.

The packages described above are formed by completely enveloping the contents in the flexible laminate. Alternatively, however, it is within the scope of the invention to employ the flexible laminate as a lidding stock for forming flexible lids that can be secured (e.g., by heat-sealing or the like) to a flange of a tray or other container that contains the contents. In this manner, the lid includes a built-in opening and reclose feature as previously described.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A recyclable packaging structure, the packaging structure comprising:
a first structure having an inner surface and an outer surface;
a second structure having an inner surface and an outer surface, wherein the outer surface of the second structure is adhesively bonded to the inner surface of the first structure, by an adhesive layer;
wherein the surface energy of the inner surface of the second structure is at least 42 dyne and the surface energy of the outer surface of the first structure is between 32-42 dyne.

2. The recyclable laminate of claim 1, wherein the surface energy of the first structure is between 34 and 40 dyne.

3. The recyclable laminate of claim 1, wherein the surface energy of the first structure is between 36 and 38 dyne.

4. The recyclable laminate of claim 1, wherein the first structure and the second structure comprise the same polymer.

5. The recyclable laminate of claim 1, wherein the adhesive layer is solvent based.

6. The recyclable laminate of claim 1, wherein the adhesive layer comprises pressure sensitive adhesive.

7. The recyclable laminate of claim 6, wherein the pressure sensitive adhesive is pattern applied.

8. The recyclable laminate of claim 6, wherein the pressure sensitive adhesive has a strong affinity for the first structure.

9. The recyclable laminate of claim 6, wherein the pressure sensitive adhesive has a weak affinity for the second structure.

10. The recyclable laminate of claim 1, wherein the first structure and the second structure are polyethylene.

11. A method of making a recyclable laminate, the method comprising:
providing a first structure, wherein the first structure defines an initial surface energy of 32 dyne or less;
providing a second structure, wherein the second structure defines a surface energy of 42 dyne or more;
applying a surface treatment to the first structure, wherein the surface treatment increases the initial surface energy to a second surface energy, wherein the second surface energy is between 32-42 dyne;
applying an adhesive layer to at least one of the first structure or the second structure; and
laminating the first structure and the second structure.

12. The method of claim 11, wherein the adhesive layer comprises pressure sensitive adhesive.

13. The method of claim 12, wherein the pressure sensitive adhesive has a weak affinity for the first structure and a strong affinity for the second structure.

14. The method of claim 11, wherein the adhesive layer is a solvent-based adhesive.

15. The method of claim 11, wherein the first structure and the second structure are polyethylene.

16. A recyclable packaging structure, the packaging structure comprising:
a first structure having an inner surface and an outer surface;
a second structure having an inner surface and an outer surface, wherein the outer surface of the second structure is adhesively bonded to the inner surface of the first structure by an adhesive layer to form a laminate, the packaging structure further comprising a repeatedly openable and closeable flexible structure which comprises, prior to initial opening:
a first score line in the laminate defining an outer layer opening portion and a second score line in the laminate defining an inner layer opening portion wherein the outer layer opening portion is larger in area than the inner layer opening portion and extends beyond a periphery of the inner layer opening portion;
the inner layer upper surface comprising a first marginal region surrounding the second score line;
a non-detachable flap, the flap comprising the outer layer opening portion and the inner layer opening portion;
the outer layer lower surface comprising a second marginal region comprising at least a portion of a periphery of the outer layer opening portion lower surface; and
the first marginal region being releasably and resealably adhered to the second marginal region, wherein at least one of the first structure or the second structure comprises polyethylene, wherein the surface energy of the polyethylene, in the first or second marginal region, is between 32 and 42 dyne, and wherein the surface area within the second score line and outside of the first score line is at least 42 dyne.

17. The recyclable laminate of claim 16, wherein the surface energy of the polyethylene structure, in the first or second marginal region, is between about 34 and 40 dyne.

18. The recyclable laminate of claim 16, wherein the surface energy of the polyethylene structure, in the first or second marginal region, is between about 36 and 38 dyne.

19. A method of making a recyclable laminate, the method comprising:
providing a first polyethylene film, wherein the polyethylene film defines an initial surface energy of 32 dyne or less;
providing a second polyethylene film;
pattern applying a first surface treatment to the first polyethylene film, wherein the first surface treatment increases the initial surface energy to a second surface energy in a reseal region, wherein the second surface energy is between 32-42 dyne;
pattern applying a second surface treatment to the first polyethylene film, wherein the second surface treatment increases the initial surface energy to a third surface energy in an area which is not the reseal region, wherein the third surface energy is at least 42 dyne;
applying an adhesive layer to at least one of the first structure or the second structure; and
laminating the first structure and the second structure.

20. The method of claim 19, wherein the adhesive layer comprises pressure sensitive adhesive.
